(19) United States
(12) Patent Application Publication
(10) Pub. No.: US 2016/0269134 A1
(43) Pub. Date: Sep. 15, 2016

(54) Audio Processing Device

(71) Applicant: Nathan Malone, Fort Wayne, IN (US)

(72) Inventor: Nathan Malone, Fort Wayne, IN (US)

(21) Appl. No.: 15/065,453

(22) Filed: Mar. 9, 2016

Related U.S. Application Data
(60) Provisional application No. 62/132,457, filed on Mar. 12, 2015.

(51) Int. Cl. H04H 60/04

(52) U.S. Cl. CPC H04H 60/04

(57) ABSTRACT

A modular audio processing apparatus that joins channels together such that four digital audio channels can be transmitted over a single connection, where the apparatus includes housing around a plurality of analog inputs, a plurality of analog outputs, a plurality of digital inputs, and a plurality of digital outputs.

### CROSS REFERENCE TO RELATED APPLICATIONS

This is a non-provisional application based upon U.S. provisional patent application Ser. No. 62/132,457 entitled “Audio Processing Devices Having Analog and Digital ADAT and SMUX Inputs and Outputs,” filed Mar. 12, 2015 which is incorporated herein by reference.

### BACKGROUND

1. Field of the Invention

The present invention relates generally to modular audio processing consoles and, more particularly, to modular audio processing consoles including a single housing for analog and digital inputs and outputs adapted for ADAT/SMUX protocols.

2. Description of the Related Art

Modular audio processing consoles used in the music and sound recording industry have existed for the last few decades, as have various rack mounted devices, but it took several years for then-existing racks to be compatible with the state-of-the-art 500 series chassis. Several 500 series chassis exist in the marketplace, and are used by musicians, music producers, and others who wish to create, modify, and otherwise work with music in its various electronic aspects. A new 500 series chassis, modified and configured to provide users with additional ways to utilize analog and digital connections (inputs and outputs) would be well received in the marketplace.

### SUMMARY

In a one exemplary embodiment, the present invention includes a modular audio processing apparatus, said apparatus comprising: a housing; a plurality of analog inputs disposed through said housing; a plurality of analog outputs disposed through said housing; a plurality of digital inputs disposed through said housing; and a plurality of digital outputs disposed through said housing.

In another exemplary embodiment, the present invention includes a modular audio processing apparatus, said apparatus comprising: a housing; a plurality of analog inputs disposed through said housing; a plurality of analog outputs disposed through said housing; a plurality of ADAT/SMUX digital inputs disposed through said housing; and a plurality of ADAT/SMUX digital outputs disposed through said housing.

In another exemplary embodiment, the present invention includes a modular audio processing apparatus, said apparatus comprising: a housing; a plurality of analog inputs disposed through said housing; a plurality of analog outputs disposed through said housing; a plurality of ADAT/SMUX digital inputs disposed through said housing; a plurality of ADAT/SMUX digital outputs disposed through said housing; and a control device adapted to distribute digital information between said inputs and said outputs in accordance with predetermined protocols.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIGS. 1A and 1B show perspective front views of a device, according to an exemplary embodiment of the present disclosure;

FIG. 2 shows a perspective back view of a device, according to an exemplary embodiment of the present disclosure;

FIG. 3 shows a perspective front view of part of a device, according to an exemplary embodiment of the present disclosure;

FIG. 4 shows a schematic of selected components within and/or used in connection with a device, according to an exemplary embodiment of the present disclosure;

FIG. 5 shows a block diagram of certain components of a device, according to an exemplary embodiment of the present disclosure; and

FIG. 6 shows a connector cable configured to connect to an input or output port of a device, according to an exemplary embodiment of the present disclosure.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

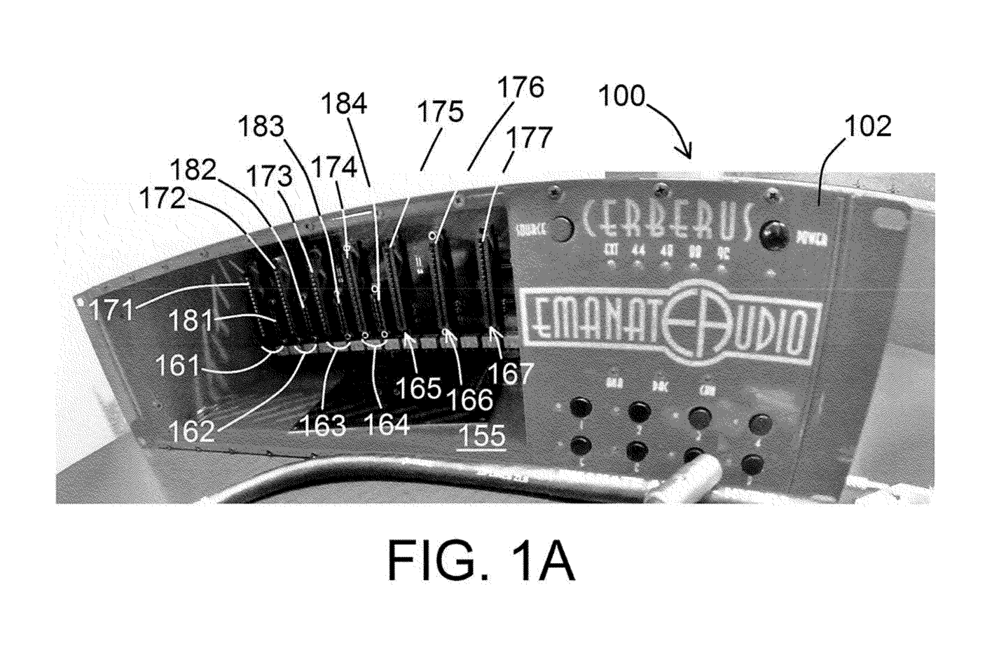

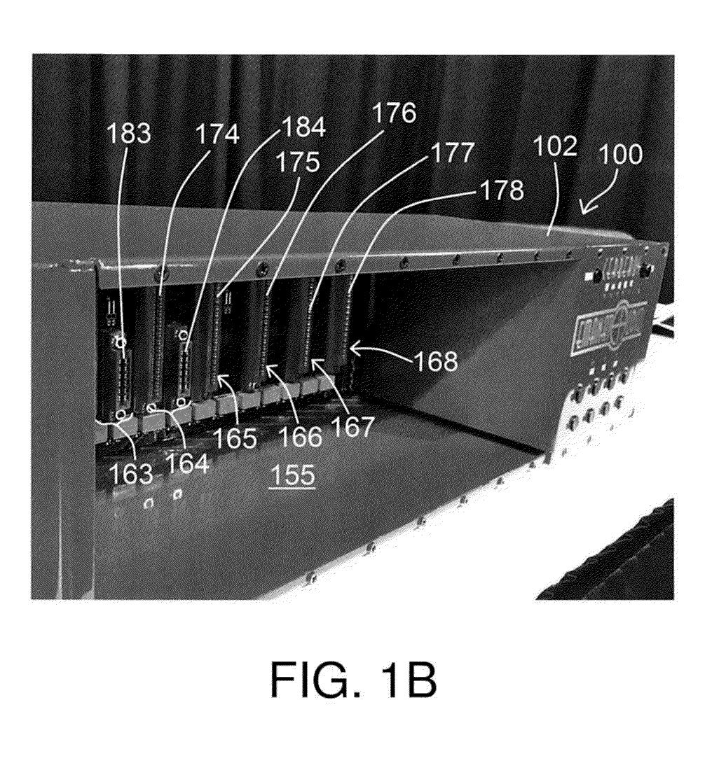

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present disclosure includes disclosure of modular chassis embodiments comprises a novel combination of inputs and outputs. Various device 100 embodiments of the present disclosure include a modular design for various effects processors and are configured to operate as described herein.

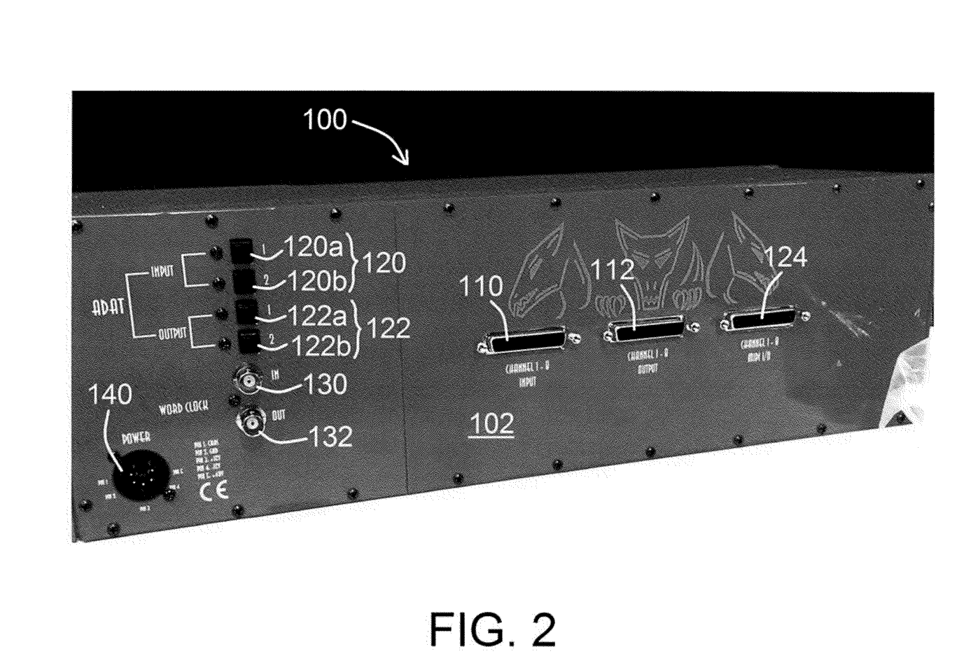

In at least one embodiment of a device 100 of the present disclosure, such as shown in FIGS. 1A and 1B, device 100 comprises a 500-series chassis (an exemplary housing 102). Devices 100, as shown in FIG. 2, comprise a housing 102 containing various components (as described in further detail herein), one or more analog inputs 110, one or more analog outputs 112, one or more digital inputs 120, and one or more digital outputs 122. In various embodiments of the present disclosures, digital inputs 120 and digital outputs 122 are in the form of Alesis Digital Audio Transfer (“ADAT”) and a form of system multiplexing (system management network protocol, or “SMUX”). In other embodiments, as referenced in further detail below, devices 100 comprise a plurality of digital inputs 120 and a plurality of digital outputs 122 in the form of ADAT and SMUX protocol.

By way of additional background, ADAT is a digital transfer language developed by Alesis. At the time the original ADAT recorders were available to the public, sample-accurate timing synchronization was introduced, where users could synchronize as many as sixteen ADAT recorders together (totaling 128 separate tracks), leading to the growth of projects studios twenty years ago. ADAT Type I recorded 16 bits per sample (at a 48 kHz sample rate), and ADAT Type II recorded 20 bits per sample (at either 44.1 kHz or 48 kHz sample rates), with each type of machine able to use high quality tapes.

Sample Multiplexing (S/MUX or SMUX) was introduced after the launch of the ADAT protocol, allowing the transmission of higher bandwidth digital audio signals over ADAT. For example, and by using SMUX, a larger 96 kHz digital stream can be transmitted by de-multiplexing to join at least two digital channels together to represent one overall higher bandwidth channel, such as at 88.2 kHz or 96 kHz as previously noted. By joining channels together, four digital audio channels can be transmitted over a single connection, originally configured/used for transmission eight audio channels at the lower bandwidths, at one of those higher bandwidths. By using a dual SMUX system, eight channels can be streamed and/or recorded at the higher bandwidths. Higher sampling rates require more, stronger, and/or faster computer processing, but they can also allow for more of an analog signal to be recorded.

FIGS. 1A and 1B show various perspective views of an exemplary device 100 of the present disclosure. As shown in one or both of FIGS. 1A and 1B, and in an exemplary device 100 embodiment, device 100 comprises eight card slots (card slots 161, 162, 163, 164, 165, 166, 167, and 168). Card slot 161 comprises a large standard slot 171 and a musical instrument digital interface (“MIDI”) control slot 181, and card slot 162 comprises a large standard slot 172 and a MIDI control slot 182. Card slot 163 comprises a large standard slot 173 and a MIDI control slot 183, and card slot 164 comprises a large standard slot 174 and a MIDI control slot 184. Card slot 165 comprises a large standard slot 175, card slot 166 comprises a large standard slot 176, card slot 167 comprises a large standard slot 177, and card slot 168 comprises a large standard slot 178. Standard slots 171, 172, 173, 174, 175, 176, 177, 178 are configured to receive standard cards or modules, while corresponding MIDI control slots 181, 182, 183, and 184 (corresponding to standard slots 171, 172, 173, and 174) are unique to devices 100 of the present disclosure and can be used to control the voltage chip(s) within device 100. MIDI control slots 181, 182, 183, and 184 are used to bring MIDI control to the CSI, as generally referenced herein. Given the use of, for example, standard slot 171 and MIDI control slot 181, within one card slot 161, a user can connect a card or other module to standard slot 171 and MIDI control slot 181 so that the card or module can be communicate with device 100 view those two slots versus just one slot, without MIDI control, as included within typical chassis known in the art. Said card slots 161-168 can be located within, for example, a recessed bay 155 defined within chassis 102, as shown in FIGS. 1A and 1B.

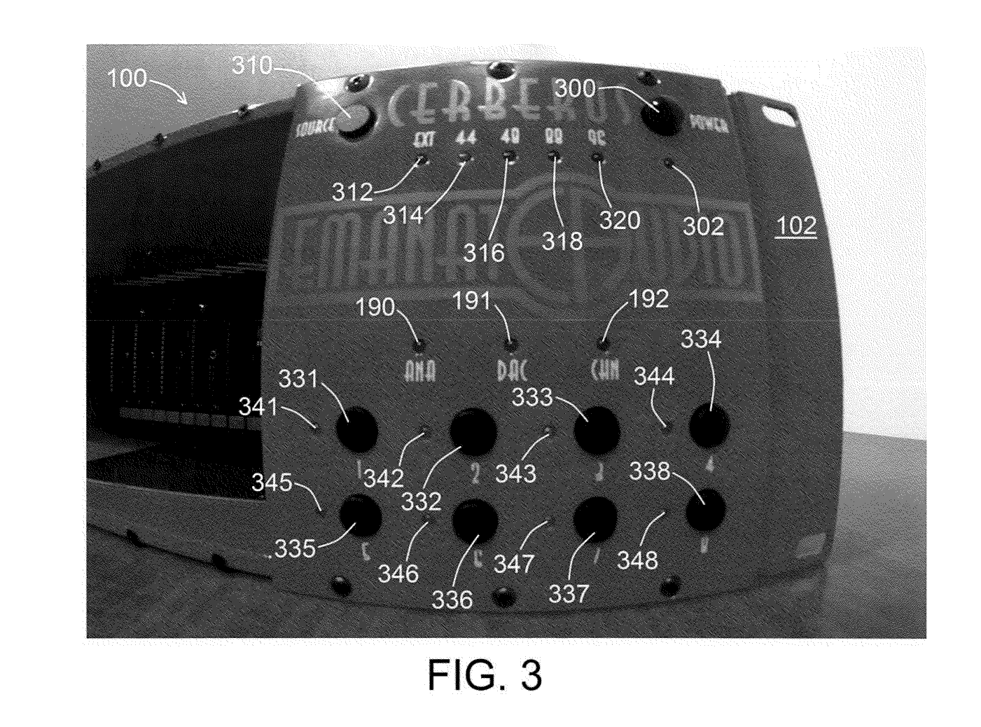

As noted above, various device 100 embodiments of the present disclosure may comprise some or all of the foregoing features and/or elements. FIG. 3 shows a relative front of an exemplary device 100 of the present disclosure, comprising a power button 300 operable to turn devices 100 on and off as may be desired. Power button 300, as well as other components/items referenced herein configured to toggle between different states (on/off, different channels, etc.) may be configured as buttons, switches, levers, etc., and are generally reference herein as “buttons.” A power light 302, such as an LED or other light, may be present so to indicate whether or not the power button 300 has been used to turn the device 100 on or off. For example, power light 302 may be illuminated when the device 100 is on and may be “dark” when device 100 is off. As such, power light 302 is electrically connected to power button 300 either directly or indirectly via other componentry of device 100 as will be referenced in further detail herein.

As shown in FIG. 3, for example, exemplary device 100 embodiments of the present disclosure comprise a source selector button 310, configured to so change/toggle from one sample rate (for which the clock is set at) to another. By using (pressing/switching, etc.) source selector button 310, and as shown in FIG. 3 for example, the sample rate can change between an external clock (as identified by external clock light 312), 44.1 kHz (as identified by 44 kHz light 314), 48 kHz (as identified by 48 kHz light 316), 88.2 kHz (as identified by 88 kHz light 318), and 96 kHz (as identified by 96 kHz light 320). These various streams/sample rates apply to the various digital signals and correspond to the rate at which the clock operates (such as, for example, 44100 times per second in the case of a 44.1 kHz rate). Other clock rates can be used with various device 100 embodiments other than those specifically referenced herein, by way of internal clock changes and/or the use of an external clock, as may be identified via external clock light 312, for example.

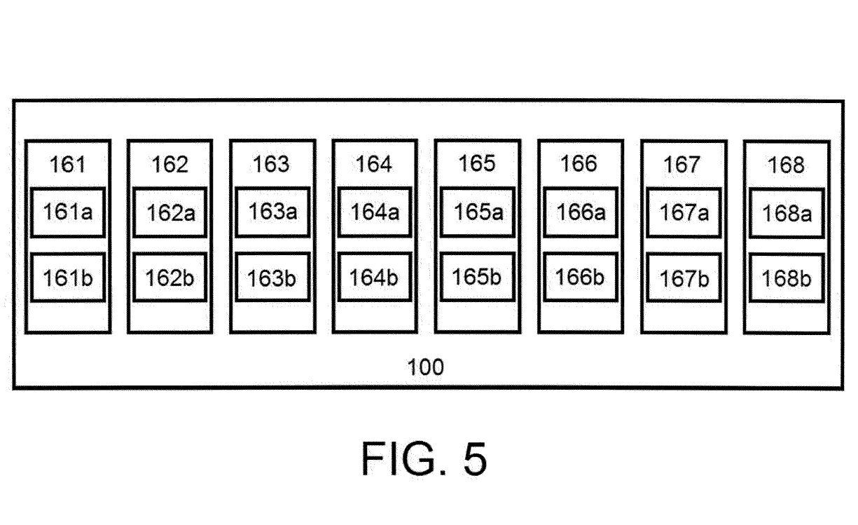

FIG. 3 also shows a series of buttons, numbered “1” through “8.” Said buttons, referred to as slot 1 button 331, slot 2 button 332, slot 3 button 333, slot 4 button 334, slot 5 button 335, slot 6 button 336, slot 7 button 337, and slot 8 button 338, are used to identify the various input sources for each card slot 161, 162, 163, 164, 165, 166, 167, 168. For example, an input source can be analog, such as a microphone, and use of a microphone or other input device could be used so that the output of card slot 161 could be fed to the input of an adjacent card slot (namely card slot 162), and so forth. As shown in the block diagram of FIG. 5, each card slot has at least one input and at least one output, so that, for example, card slots 161, 162, 163, 164, 165, 166, 167, 168 correspond to card slot inputs 161a, 162a, 163a, 164a, 165a, 166a, 167a, 168a, respectively, and card slot outputs 161b, 162b, 163b, 164b, 165b, 166b, 167b, and 168b, respectively.

FIG. 3 also shows a series of additional lights, identified as “ANA,” “DAC,” and “CHN.” Analog light 190 (shown as “ANA”), digital to analog converter light 191 (shown as “DAC”), and channel light 192 (shown as “CHN”) can each illuminate as one or more colors, in various embodiments, to describe the behavior of lights 341, 342, 343, 344, 345, 346, 347, 348 as referenced below. A microcontroller (processor 400) present within device 100 can be used to relay information from the user (by way of pressing one or more of slot buttons 331, 332, 333, 334, 335, 336, 337, 338 one or more times) to and through the circuitry within device 100 to control the same as generally referenced herein. In various embodiments, slot buttons 331, 332, 333, 334, 335, 336, 337, 338 have corresponding slot button lights 341, 342, 343, 344, 345, 346, 347, 348, respectively.

For example, and in an exemplary use of a device 100 of the present disclosure, a first card could be connected to card slot 161 and a second card could be connected to adjacent card slot 162. A microphone could be connected as an analog input device via analog input 110. The microphone is then fed to and controlled using card slot 161 by way of circuitry within device 100, and the output 161b of card slot 161 can be fed into the input 162a of card slot 162, effectively connecting card slots 161 and 162 in series.

There are three input sources for all card slots 161, 162, 163, 164, 165, 166, 167, 168. For example, if slot 1 button 331 is pushed, it will toggle between analog input (where analog light 190 would illuminate and digital to analog converter light 191 would be unlit) and digital to analog converter input (where digital to analog converter light 191 would illuminate and analog light would be unlit). No option for “CHN” so to illuminate channel light 192 would be an option for slot 1 button 331, as that input would be associated with an adjacent card to the immediate left of card slot 161 (considered as an “n−1” (“n” minus one)), with the current card slot (here card slot 161) being the “n.” As no “n−1” exists (no card slot to the immediate left of card slot 161), an input from that adjacent channel would not apply. However, a first card is in card slot 161 and a second card is in card slot 162, a user can toggle slot 2 button 322 to start the analog input (which may be the default input, such as to select the microphone as described above) and analog light 190 may illuminate, and if pressed again the input may come from the digital to analog converter (DAC) 410 identified by way of illumination of digital to analog converter light 191, and if pressed again (going to channel mode), channel light 192 may illuminate and analog light 190 may turn off to identify the same, whereby the input comes from the adjacent card in card slot 161 (which is the effective “n−1” for card slot 162). In some embodiments, and by default, the analog input mode may be the default mode, and pressing slot 2 button 332 (or another slot button) can change where that corresponding card slot 161 gets its input. In various other device 100 embodiments, the sequence of changes from one input to another may differ, such as from analog to channel (adjacent input) then to the digital to analog converter, for example. The various lights 190, 191, 192 may turn on one color and then off, or may cycle through various colors (such as red and white, for example) and then turn off to indicate that a particular input is not being used.

As shown in FIG. 3, in an at least one device 100 embodiment of the present disclosure, eight buttons are present to control/select the input source for the various card slots. It is noted that the various features and/or components referenced here may be positioned upon and/or within various portions of exemplary devices 100, such as a relative front, back, side(s), top, or bottom, as may be desired for a particular application/embodiment.

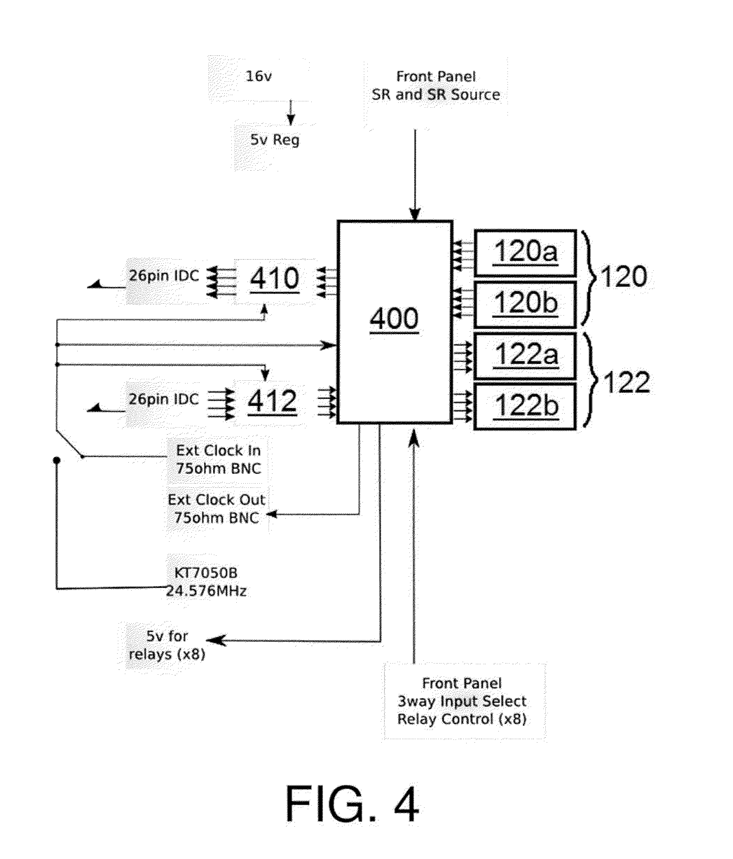

FIG. 2 shows a portion of a relative back of an exemplary device 100 of the present disclosure. As shown therein, two digital inputs 120 (further identified as 120a and 120b) and two digital outputs 122 (further identified as 122a and 122b) (both optical) are shown as being associated with ADAT. Said optical connectors (inputs 120 and outputs 122) are used in connection with the digital transfer protocol referenced herein. In at least one embodiment, and as shown in the circuitry schematic of FIG. 4, digital input 120a may comprise an optical ADAT input, digital input 120b may comprise an optical SMUX input, digital output 122a may comprise an optical ADAT output, and digital output 122b may comprise an optical SMUX output. Each digital input 120 and digital output 122 may directly (as shown in FIG. 4) or indirectly connected to a central processor 400, so that input data from digital inputs 120 can be processed by central processor 400, and central processor 400 can send output data to digital outputs 122. A digital to analog converter 410 and an analog to digital converter 412, as shown in FIG. 4, are also in electrical communication with processor 400 and operable as referenced herein. Other elements shown in the diagram shown in FIG. 4 can be directly or indirectly connected to one another via one or more wires and/or circuits, and the elements shown in FIG. 4, whether it be all the elements or some of the elements, may generally be referred to herein as circuitry.

A word clock input 130 and a word clock output 132 are also shown in FIG. 2, so that, for example, an external clock (not pictured) can be connected to device 100 via word clock input 130 and/or word clock output 132, which can be selected for use by device 100 by way of source selector button 310 as previously referenced herein. For example, a master external clock can be used to set device 100 and all peripherals used in connection therewith to the same clock/rate. Word clock input 130, for example, can be used to set a clock for another device, while word clock output 132 can, for example, use a critical oscillator on a card to clock other peripherals to a clock of interest.

A power input 140, such as shown in FIG. 2, can be used to connect a source of power to device 100 so to provide power thereto. An external switching 16V power supply, or another suitable power supply, can be connected to device 100 by way of power input 140 so to provide the necessary power to operate device 100. In at least one embodiment, power input 140 is configured as a 5-pin locking XLR.

The “CHANNEL 1-8 INPUT” shown in FIG. 2 is an exemplary analog input 110 of the present disclosure. An exemplary analog input 110, as shown in FIG. 2, comprises a DB-25 (25-pin female connector), including pinouts for each channel, with each input being electrically connected to a corresponding slot 161 through 168 on the front of the chassis (housing 102 of device 100). For example, and in the case of a DB-25 connector as analog input 110, said input 110 permits up to eight channels of balanced audio by way of using eight positive connectors, eight negative connectors, and eight grounds, with one pin not being used. Exemplary analog inputs 110 can be used, for example, to ultimately convert MIDI data into full voltage data using componentry within device 100, such as digital conversion to analog control of a circuit. Various devices including, but not limited to, keyboards, MIDI interfaces, microphones, other mixers, other processors, etc., can be connected to device 100 by way of analog input 110. In at least one use of analog input 110, eight XLR connectors can be operably connected to analog input 110 by way of splitting an XLR cable from one plug portion (to plug into analog input 110) to eight separate connectors.

The “CHANNEL 1-8 OUTPUT” shown in FIG. 2 is an exemplary analog output 112 of the present disclosure. An exemplary analog output 112, as shown in FIG. 2, also comprises a DB-25 (25-pin female connector), including pinouts for each channel, with each input being electrically connected to a corresponding slot 161 through 168 on the front of the chassis (housing 102 of device 100). Use of analog output 112 provides feedback to components within device 100 to select from various input devices coupled thereto, such as other mixers, sound cards, and generally any sort of electronic equipment having an analog input.

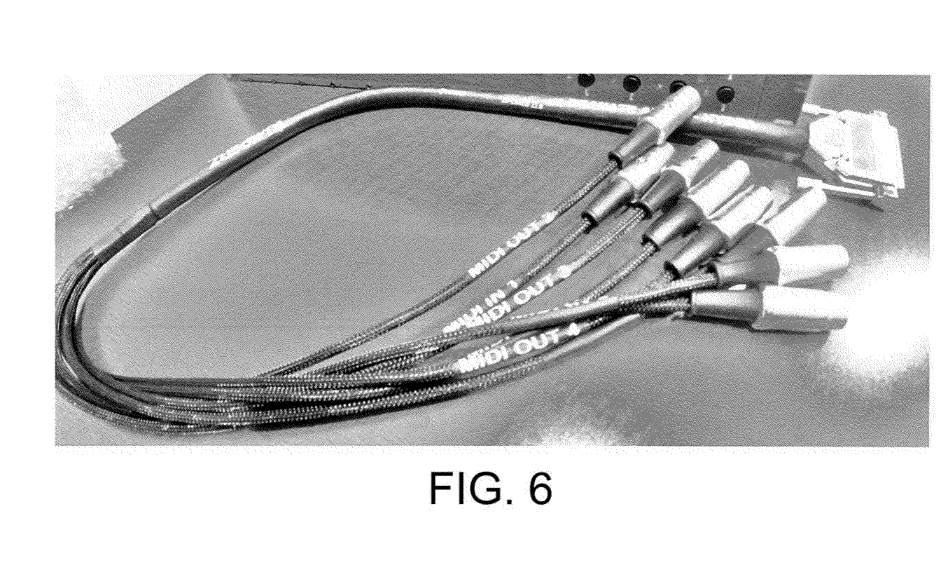

The “CHANNEL 1-8 MIDI I/O” shown in FIG. 2 is an exemplary MIDI input and output connector (referenced herein as MIDI I/O 124) which can be used, for example, to connect two keyboards, to use one keyboard to control another, and/or to control data from one computer into a module that is positioned within one of card slots 161 through 168. A MIDI multi-cable, such as shown in FIG. 6, can be connected to MIDI I/O 124, for example, and allow connection to four MIDI inputs and four MIDI outputs as may be desired by the end user.

Various exemplary devices 100 of the present disclosure may have the following features, elements, requirements, and/or componentry to achieve one or more of the same:

a. each card slot input (161a through 168a) and output (161b through 168b) is routed to their relative chain switches, and as noted above, the inputs 161a through 168a can be independently selected among analog, digital (digital to analog converter), or the previous channel; and/or

b. when a particular chain switch (x, or n−1 as previously referenced) is disengaged, the corresponding card slot output (x or n−1) is routed to the analog output 112 (DB 25, for example), in parallel to the ADC; and/or

c. when a subsequent chain switch (x+1, or n as previously referenced) is engaged, card slot x or n−1 output is routed to the input of card slot x+1 or n, in parallel to the ADC; and/or

d. all card slot inputs 161a through 168a shall receive independent signals from the digital to analog converter (DAC), noting that the DAC shall always send the signal, but switchably routed to the card slot; and/or

e. each card slot 161 through 168 shall have three (or a different desired number of) inputs, DAC, previous (x or n−1) output, or analog; and/or

f. all card slot outputs 161b through 168b shall send signals to the ADC at all times, regardless of the switch settings, noting that the output is buffered so to split out the high impedance signal at +4 db; and/or

g. each card slot 161 through 168 shall have two live outputs, ADC and analog; and/or

h. the ADC connection is a pre-feed switch; and/or

i. all analog circuits are balanced; and/or

j. DB25 connections follow the Tascam analog standard; and/or

k. DB25 for MIDI (MIDI I/O 124) is based on the Tascam analog standard; and/or

l. all voltage, grounds, and audio on card slots 161 through 168 follow VPR Alliance standards; and/or

m. a link switch is used so that when it is engaged it connects a link bus between adjacent cards allowing for linked detector circuits in a compressor; and/or

n. ADC is fed from card output x (or n−1) before the feed switch to IDC out; and/or

o. DAC feeds card input x (or n−1) after the feed switch from IDC in; and/or

p. power is 16V+/− at 250 mA per card slot 161 through 168a;

q. digital inputs 120 and digital outputs 122 shall follow the ADAT protocol at

44.1 kHz and 48 kHz and SMUX at 88.2 kHz and 96 kHz; and/or

r. full duplex is achieved using eight channels in and out using two optical connectors simultaneously at 44.1 kHz and 48 kHz; and/or

s. full duplex is achieved using eight channels in and out using four optical connectors simultaneously at 88.2 kHz and 96 kHz; and/or

t. the digital clock follows the external clock for the sample rate when set to external; and/or

u. when the clock is set to external the output shall be internally terminated (where the word clock out is internally terminated when the sample rate is set to external); and/or

v. when the clock is generated internally it sends clock signals to the word clock out on 75 Ohm BNC (where the word clock out signal is generated internally when set to any clock speed); and/or

w. when the sample rate is 88.2 kHz or 96 kHz, whether internally or using an external clock, the channel count is cut in half on the converter; and/or

x. the word clock in and out is on a 75 Ohm BNC connector; and/or

y. the clock settings shall be set using a switch on the front part of the housing 102;

z. there are four 6 pin EDAC routes to the DB25 MIDI I/O 124; and/or

aa. the DB25 MIDI I/O 124 carries four MIDI in and four MIDI out; and/or

bb. each 6 pin EDAC connector is a pass through, noting that the card that goes into the particular slot can use, for example, a small ribbon going to the main card, and both cards can be mounted together; and/or

cc. 6 pin EDAC connectors all go to an IDC for future expansion; and/or dd. the IDC also goes to the DB25 MIDI I/O 124; and/or

ee. disengagement of the DAC switch (user interface) turns the DAC off and does not load the analog input for the modules; and/or

ff. engagement of the DAC switch (user interface) turns the DAC on and loads the analog input and sends signals to the modules; and/or

gg. the DAC switch (user interface) works for all eight channels of the DAC at once; and/or

hh. exist as an eight (8) slot 500 series rack with ADAT out and MIDI control (MIDI input and output to every channel, which also allows analog inputs and outputs; and/or

ii. an exemplary DB-25 pinout connector (“CHANNEL 1-8 INPUT”) includes pinouts for each of the eight channels, with each input being electrically connected to each corresponding slot on the front of the chassis; and/or

jj. each slot can correspond to one API module, or, for example, two slots can be used together as a double-width module, where exemplary API modules include, but are not limited to, preamplifiers (preamps), equalizers, direct input modules, compressors, and the like; and/or

kk. be configured as an eight-slot 500 series rack with analog and digital inputs and outputs over the ADAT/SMUX protocol, with an achievable bandwidth of 96 kHz; and/or

ll. include a feed switch present for every channel so that a user of device 100 can feed the output of channel 1, for example, to the input of channel 2; and/or

mm. MIDI inputs and outputs are available to every channel; and/or

nn. be configured ADAT/SMUX, going from 44.1 kHz to 96 kHz on all eight channels, in and out; and

oo. each card slot 161 through 168 delivers at least 250 mA of power; and/or

pp. each card slot 161 through 168 can “hold” a 500-series module; and/or

qq. be configured for rack mounting; and/or

rr. include ADC and DAC chipsets.

As generally referenced above, the 500 series format has been around for decades. ADAT protocol has also been around for decades, but no one has ever put an ADAT/SMUX digital input and output section on a 500 series chassis until devices 100 of the present disclosure. Because many audio interfaces have ADAT ports that are underutilized or ignored, the present disclosure includes disclosure of a 500 series chassis that could be attached to these ports so people could use 500 series equipment with their audio interfaces through these unused ports without purchasing an additional outboard converter. Prior to devices 100 of the present disclosure, if a user wanted to take advantage of an ADAT port on an audio interface with 500 series equipment, the user would have to purchase an analog to digital converter and a digital to analog converter. Most eight channel ADC/DACs currently cost between $1,500-$4,000. As can be understood from the present disclosure, both the 500 series standard and ADAT have been around for decades, but they have not been used together prior to the devices 100 of the present disclosure, as it is not a natural progression to merge the two of these together. On the analog to digital side, the present disclosure includes disclosure of splitting the signal for redundant recordings, if the user so chooses, to both an analog output and to the analog to digital converter and ADAT encoder. The digital to analog converter and ADAT connection allow for the 500 series modules to be used as audio processors in a previously recorded session, for example.

In at least one embodiment of an exemplary device 100 of the present disclosure, device 100 is an eight slot VPR Alliance compatible 500 series chassis with ADAT in and out in addition to the standard analog ins and outs. The digital converter operates at 24 bit with selectable sample rates up to 96 kHz external. Slots two through eight (card slots 162 through 168) feature a feed switch to send the previous card's output to the subsequent card input allowing for the creation of channel strips and additional routing flexibility. A built in link feature allows for stereo linking of adjacent modules 1-2, 3-4, 5-6 and 7-8.

Various features of an exemplary digital converter card of the present disclosure include ADAT in and out by way of optical connectors, 24 bit with selectable internal sample rates up to 96 kHz or external, a field programmable gate array (“FPGA”) application, FPGA chipset (where FPGA is Xilinx Spartan 6 processor 400 in at least one example), converter chipsets—PCM4420 and PCM1798, and clocking—internal and external word clock. Various other chips/chipsets, such as other FPGA chips or other AD/DA converters/chips can be used and are within the scope of the present disclosure.

In general, any computer audio interfaces, professional digital mixers and standalone digital recorders feature ADAT or SMUX optical inputs and outputs. Exemplary devices 100 of the present disclosure can receive audio from or send audio to these often underused digital connections. In addition, exemplary devices 100 can send and receive analog audio information in the form of microphone level signal, line level and high Z. MIDI data can be received and transmitted to devices 100, for example, via the 6 pin edge card connector that is associated with 4 of the channels.

End users of exemplary devices 100 of the present disclosure may range from aspiring home recording enthusiasts to professional recording, mixing and live sound engineers. Some basic understanding of digital audio and clocking practice is required to integrate devices 100 into their systems. End user would likely have professional audio equipment with ADAT or SMUX in/out that can also send or receive word clock from a BNC connection. End users would also likely have a balanced patchbay. End users shall have processing modules that go into the device 100 card slots to complete the system.

In various embodiments, devices 100 of the present disclosure have a discrete eight channel front end for an ADAT input system. The end user has the ability to load the chassis with eight 500 series modules that will take an incoming microphone signal, for example, and pass the line level audio output signal to the ADAT section of the chassis to allow for digital transfer via ADAT or SMUX protocols.

Various device 100 embodiments may also have four stereo front ends for an ADAT input system, allowing the end user to load the chassis with four stereo modules or eight mono modules being linked together to behave as four stereo. Channel 1 will link to 2, channel 3 to 4, channel 5 to 6, and channel 7 to channel 8. The outputs of each channel will pass the output signal to the ADAT section of the chassis to allow for digital transfer via ADAT or SMUX protocols.

Various device 100 embodiments may have three module stereo front ends for an ADAT system, providing the end user with the ability to load the chassis with two sets of three modules to create two channel strips that can be comprised of, for example, a microphone pre-amp, compressor and equalizer. The audio signal would enter into the input of channels 1 & 4. The output of channel 1 will feed the input of channel 2. This will also happen on where channel 4 output feeds channel 5 input. Channel 2 output will feed channel 3 input. Channel 5 output will feed channel 6 input. Channels 3 & 6 outputs will pass the output signal to the ADC to allow for digital transfer via ADAT or SMUX protocols. The ADC outputs from every card feed the digital card, but while the feed switch is engaged the analog output will feed the input of the subsequent channel until the feed switch is disengaged. The analog output will be routed to the XLR output on the last channel of the chain. In this example, the analog output is routed to XLR output channels 3 & 6.

Various device 100 embodiments may comprise a discrete eight channel hardware insert for ADAT input and output systems—external ADAT out to the ADAT in. DAC out to card slot input (x), card slot output(x) to ADC, ADC to ADAT out to external ADAT in.

While various devices and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A modular audio processing apparatus, said apparatus comprising:
a housing;
a plurality of analog inputs disposed through said housing;
a plurality of analog outputs disposed through said housing;
a plurality of digital inputs disposed through said housing; and
a plurality of digital outputs disposed through said housing.

2. A modular audio processing apparatus, said apparatus comprising:
a housing;
a plurality of analog inputs disposed through said housing;
a plurality of analog outputs disposed through said housing;
a plurality of ADAT/SMUX digital inputs disposed through said housing; and
a plurality of ADAT/SMUX digital outputs disposed through said housing.

3. A modular audio processing apparatus, said apparatus comprising:
a housing;
a plurality of analog inputs disposed through said housing;
a plurality of analog outputs disposed through said housing;
a plurality of ADAT/SMUX digital inputs disposed through said housing;
a plurality of ADAT/SMUX digital outputs disposed through said housing; and
a control device adapted to distribute digital information between said inputs and said outputs in accordance with predetermined protocols.
